(19) United States
(12) Patent Application Publication
(10) Pub. No.: US 2024/0003219 A1
(43) Pub. Date: Jan. 4, 2024

(54) COMPOSITE WEDGE AND RELATED METHODS

(71) Applicant: CCDI Composites, Inc., Santa Ana, CA (US)

(72) Inventor: Steven Koon Hung Sim, Placentia, CA (US)

(21) Appl. No.: 18/337,226

(22) Filed: Jun. 19, 2023

Related U.S. Application Data
(60) Provisional application No. 63/366,677, filed on Jun. 20, 2022.

(51) Int. Cl. E21B 33/129

(52) U.S. Cl. CPC E21B 33/1291

(57) ABSTRACT

A composite slip wedge for a frac plug or bridge plug used in oil and gas production has a tapered wedge surface. A first portion of the slip wedge is formed of layers of fibers entrained in an epoxy matrix, in which the layers are directed generally parallel to an axis of the plug. The second portion of the slip wedge has layers of fibers that are inclined relative to the plug axis. The second portion is at or adjacent the tapered wedge surface so that a set force applied to the tapered wedge surface in a direction parallel to the plug axis is directed transverse to the fiber layers in the second portion of the slip wedge.

### BACKGROUND

The present disclosure relates to the field of downhole tools such as frac and bridge plugs.

Oil and gas well operations can include multi-zone hydraulic fracturing processes that employ zonal isolation. Frac and bridge plugs are often used to establish such zonal isolation. Frac and bridge plugs can be advanced to a desired location within a well and then expanded, or set, so as to sealingly engage the well casing in order to provide zonal isolation.

Typically, such frac and bridge plugs include an engagement portion comprising upper and lower slip rings and associated slip wedges that sandwich a seal portion. To set the plug, the engagement portion typically is longitudinally compressed. The slip wedges have an inclined wedge surface, and thus compression of the engagement portion results in each slip wedge urging the associated slip ring radially outwardly and into engagement with the well casing so as to mechanically engage the well casing and hold the plug in position. The seal portion, when longitudinally compressed, deforms radially to engage and establish a seal with the well casing.

Frac and bridge plugs are often made of composite materials so as to make them easier to remove, such as by drilling, when they are no longer needed. For example, slip wedges can be formed by filament-winding a composite fiber, such as fiberglass, into a cylinder and then machining the cured part to the desired wedge shape. A substantial volume of material is thus removed during such machining. Also, during the setting process, when the slip ring slides over and is expanded radially by the slip wedge, substantial forces are exerted on the slip wedge. Such forces include longitudinal forces that are directed in generally the same direction as the layers of fibers within the slip wedge, leading to substantial interlaminar, or in-plane, shear forces.

### SUMMARY

The present disclosure discloses aspects that improve both the performance and manufacturability of components such as composite slip wedges. For example, some embodiments disclose composite slip wedges having a first portion in which layers of fiber-reinforced composite are directed generally parallel to the axis of the slip wedge, while in a second portion layers of fiber-reinforced composite materials are directed transverse to the wedge axis, such as at an angle about the same as the inclined wedge surface. The present disclosure also discusses methods of making such slip wedges such as by using a filament-winding process to first form the first portion, and in which the first portion has an inclined edge. The second portion can then be wound atop the first portion, and takes on the incline of the first portion's inclined edge. More embodiments and inventive features are discussed below.

In accordance with one embodiment, a composite bridge plug comprises an elongated plug mandrel having a longitudinal axis and supporting an expansion portion. The expansion portion comprising a seal part, a slip ring, and a slip wedge between the seal part and the slip ring. The slip wedge has an inclined wedge surface disposed in engagement with the slip ring and inclined at a wedge angle relative to the longitudinal axis. The expansion portion is configured to be longitudinally compacted upon application of a set force that is applied in a direction parallel to the longitudinal axis. The slip ring and slip wedge are configured so that when the expansion portion is longitudinally compacted the slip ring engages the wedge surface and slides longitudinally over the wedge surface and is pushed radially outwardly by the wedge surface. The slip wedge comprises a first portion and a second portion, the first portion comprising a plurality of first layers of fibers encased in a matrix, the first layers of fibers being substantially parallel to the longitudinal axis, the second portion comprising a plurality of second layers of fibers encased in a matrix, the second layers of fibers being inclined and transverse to the first layers of fibers.

In some such embodiments, the slip ring comprises a tapered slip ring surface, and the tapered slip ring surface is adjacent the wedge surface.

Some embodiments additionally comprise a set structure configured to communicate a set force to the expansion portion, the set force being exerted in a longitudinal position onto the wedge surface.

In accordance with another embodiment, the present disclosure provides a composite slip wedge, comprising an elongated body having a longitudinal axis and an axial opening along the longitudinal axis. The elongated body extends circumferentially about the longitudinal axis. An inner surface faces the axial opening. An outer surface is opposite the inner surface. A wedge surface intersects the outer surface, the wedge surface inclined at a wedge angle. A first portion of the body comprises a plurality of first layers of fibers entrained in a cured composite matrix, each of the plurality of first layers extending generally parallel to the longitudinal axis. A second portion of the body comprises a plurality of second layers of fibers entrained in the cured composite matrix. At least a portion of each of the plurality of second layers of fibers extend in a direction transverse to the longitudinal axis.

In some embodiments, the second portion is interposed between the wedge surface and the first portion. In some such embodiments, at least a portion of the plurality of second layers of fibers extends in a direction inclined at a second layer angle within ±5° of the wedge angle. In further embodiments a first end of the first portion can be inclined at a first portion angle within ±5° of the wedge angle. The second portion can be attached to the first portion, and an innermost second layer of the second portion can be in direct contact with the first portion.

In additional embodiments, the wedge surface is formed in the second portion.

In accordance with yet another embodiment the present disclosure provides a method of making a composite slip wedge. The method includes forming a wedge preform, which comprises filament-winding a plurality of first layers of matrix-entrained fibers on a mandrel and successively on top of one another to form a first portion having an outer edge shape. A first edge portion of the outer edge shape being inclined at an edge angle that is transverse to a longitudinal axis of the mandrel, the plurality of first layers being generally parallel to the longitudinal axis. The method further includes filament-winding a plurality of second layers of matrix-entrained fibers atop the first portion so that the plurality of second layers generally take on the outer edge shape of the first portion, the plurality of second layers forming a second portion, the second layers in an inclined part of the second portion being directed substantially at the edge angle. The matrix is cured. Then material is removed, such as by machining, from an outer surface of the wedge preform at the inclined part to form a smooth wedge surface, the wedge surface having a wedge angle relative to the longitudinal axis that is within ±10° of the edge angle.

In an additional embodiment the wedge angle is substantially the same as the edge angle.

In a yet additional embodiment a first end of each successive first layer in the first portion is longitudinally spaced from a first end of the previous first layer atop which the successive first layer is wound, and the edge angle is determined by comparing a line through the first ends to the longitudinal axis.

In some embodiments, each winding pass forms a layer.

Additional embodiments comprise forming a strand of fibers into a generally flat tape prior to winding the fibers onto the mandrel, and the direction of each layer is consistent with the flat plane of the flat tape.

Further embodiments can comprise removing material from the wedge preform so that it is symmetrical about a line of symmetry perpendicular to the longitudinal axis, and cutting along the line of symmetry to form the slip wedge and a second slip wedge.

In yet further embodiments, a plurality of wedge preforms can be simultaneously filament-wound on the mandrel.

Aspects of the invention further include a composite frac plug or bridge plug, comprising: an elongated mandrel having a longitudinal axis and supporting an expansion portion, the expansion portion comprising a seal part, a slip ring, and a slip wedge between the seal part and the slip ring, the slip wedge having an inclined wedge surface disposed in engagement with the slip ring and inclined at a wedge angle relative to the longitudinal axis; the expansion portion configured to be longitudinally compacted upon application of a set force that is applied in a direction parallel to the longitudinal axis; wherein the slip ring and slip wedge are configured so that when the expansion portion is longitudinally compacted the slip ring engages the wedge surface and slides longitudinally over the wedge surface and is pushed radially outwardly by the wedge surface; and the slip wedge comprising a first layer defining a bore of the slip wedge, a second layer disposed over the first layer, a third layer disposed over the second layer, and at least three additional layers disposed over the third layer that include an outermost layer, and wherein the outermost layer is formed from a filament layer having a length that is longer than a length of the first layer, a length of the second layer, and a length of the third layer.

A still further aspect of the invention includes a composite slip wedge, comprising: an elongated body having a longitudinal axis and an axial opening along the longitudinal axis, the elongated body extending circumferentially about the longitudinal axis; an innermost surface facing the axial opening; an outermost surface opposite the inner surface; a wedge surface intersecting the outermost surface, the wedge surface inclined at a wedge angle; a first layer defining the innermost surface of the slip wedge, a second layer disposed over the first layer, a third layer disposed over the second layer, and at least three additional layers disposed over the third layer that include the outermost layer; and wherein the outermost layer is formed from a filament layer having a length that is longer than a length of the first layer, a length of the second layer, and a length of the third layer.

A yet further aspect of the invention includes a method of making a composite slip wedge, comprising: forming a wedge preform, forming the wedge preform comprising: filament-winding a plurality layers of matrix-entrained fibers on a mandrel and successively on top of one another; wherein the plurality of layers comprise a first layer defining a bore of the preform, a second layer disposed over the first layer, a third layer disposed over the second layer, and at least three additional layers disposed over the third layer that include an outermost layer; and wherein the outermost layer is formed from a filament layer having a length that is longer than a length of the first layer, a length of the second layer, and a length of the third layer.

The preform can have a prolate spheroid shape.

A midpoint of the preform can have a thickness that is wider than a thickness at each of two ends of the preform.

The method wherein each winding pass forms a layer.

The method can comprise laying a strand of fibers that form the outermost layer to a section of a matrix of a first preform to form an innermost layer of a second preform.

The method can comprise laying a strand of fibers that form the outermost layer of the second preform to another section of the matrix to form an innermost layer of a third preform.

Method of making and of using preforms, wedges for frack and bridge plugs, and frac and bridge plugs comprising wedges made from a wedge preform of the invention.

### BRIEF DESCRIPTION OF THE DRAWINGS

FIG. 1 is a longitudinal cross-sectional view of an example frac plug arranged in a well casing;

FIG. 2 shows the plug of FIG. 1 in a set position;

FIG. 3 is a schematic view of an example filament winding apparatus;

FIG. 4A is a half sectional view of a wedge preform that has been filament-wound, depicting layers of filaments schematically as lines;

FIG. 4B is a half sectional view of a slip wedge formed by machining the wedge preform of FIG. 4A, depicting layers of filaments schematically as lines;

FIG. 5 is a sectional view schematically depicting a first portion of a wedge preform, depicting layers of filaments schematically as lines wound upon a mandrel;

FIG. 6 shows the arrangement of FIG. 5 schematically depicting a second portion of the wedge preform wound atop the first portion so as to form a wedge preform, and depicting layers of filaments schematically as lines;

FIG. 7 is a half sectional view of a slip wedge machined from the wedge preform of FIG. 6, depicting layers of filaments schematically as lines;

FIG. 8 is a sectional view of a plurality of filament wound wedge preforms disposed on a mandrel and depicting layers of filaments schematically as lines;

FIG. 9 shows the arrangement of FIG. 8 partially machined;

FIG. 10 is a sectional view schematically depicting another wedge preform accordance with aspects of the invention, depicting layers of filaments schematically as lines wound upon a mandrel form inside out;

FIG. 11 is a schematic depiction of the filament being wound layer-by-layer to form the preform in a helix-like pattern from the inside out in both the radial and axial directions; and

FIG. 12 depicts several wedge preforms formed in series to create a plurality of preforms each with similar patterns.

### DESCRIPTION

The present specification discloses innovative structures for composite frac plugs and bridge plugs, and in particular slip wedges for such plugs. Embodiments for manufacturing such structure are also discussed. As will be discussed in more detail below, a slip wedge having an inclined wedge surface is formed by filament-winding a wedge preform that is then machined to the desired size of the slip wedge. During the filament-winding process, a portion is wound so that the layers of fibers extend at an angle approximating the incline of the wedge surface. Another portion is wound so that the layers of fibers are generally parallel to an axis of the slip wedge. The wedge surface is subjected to an axially-directed set force F applied to the wedge surface during a setting process. Since the fiber layers at the wedge surface are inclined, the set force F is directed transverse to the fiber layers, reducing interlaminar shear forces and reducing the likelihood of interlaminar shear failures. Also, the fiber layers that are parallel to the axis provide excellent hoop strength to help push a slip ring sliding over the slip wedge radially outwardly.

As will also be discussed in more detail below, a wedge preform is first made using a filament winding process in which layers of filament are laid over a mandrel. A first group of layers of filament are laid down in a direction generally parallel to the mandrel. As first layers build upon one another, the lengths of the layers are reduced so that the resulting first wound portion is inclined on its opposing side edges. A second wound portion includes a plurality of second layers wound atop the first wound portion. As such, the second layers follow the inclines and contours of the first portion. As a result, the first layers of fibers are generally parallel to the mandrel, but the second layers of fibers are inclined on opposite sides of the preform, and thus are transverse to the first layers.

After the preform is cured, a machining process reduces the preform outer diameter to a desired size and divides the preform in half so as to make two slip wedges from a single wound preform, each having an inclined wedge surface that approximates the incline of the second layers of fibers. In this manner, the slip wedge can be formed in a manner that minimizes the required machining to transform the wedge preform into two slip wedges.

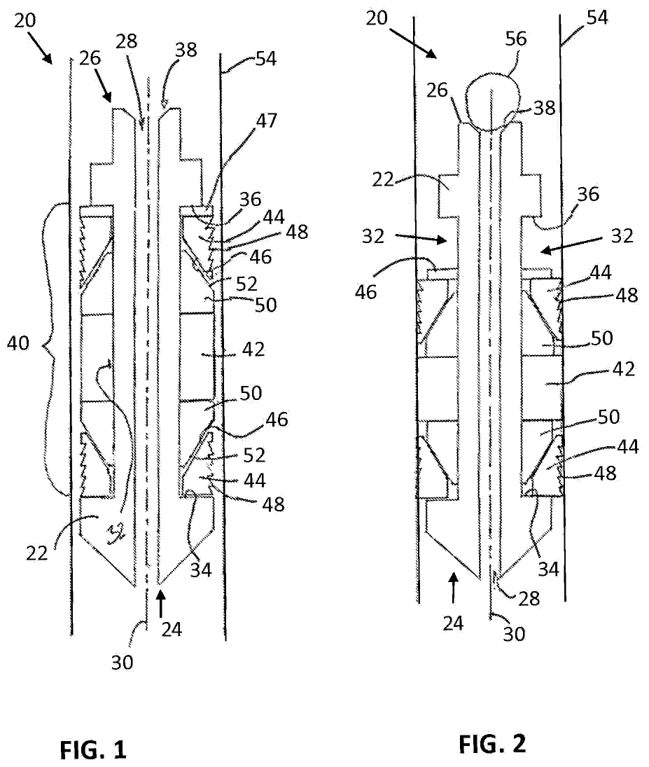

With initial reference to FIG. 1, an example frac plug or bridge plug 20 is depicted placed within a well casing 54. For simplicity, the frac plug or bridge plug will herein simply be referred to as “plug 20”, which can represent either of the two plug types. The plug 20 includes an elongated plug mandrel 22 having a distal end 24, a proximal end 26, and a lumen 28 extending longitudinally therethrough along a longitudinal axis 30. A circumferential slot 32 is formed around the plug mandrel 22 and extends from a slot distal wall 34 to a slot proximal wall 36. In alternative examples, a sleeve can be located over the proximal end of the mandrel 22 to provide the proximal wall and a nose section can be located over the distal end of the mandrel 22 to provide the distal wall, which in combination forms a slot therebetween for receiving various plug components, as further discussed below. A ball seat 38 can be formed at the proximal end 26 and aligned with the lumen 28.

Continuing with reference to FIG. 1, an engagement portion 40 is disposed within the slot 32. A seal part 42 of the engagement portion 40 is sandwiched between a pair of slip wedges 50. Each slip wedge 50 has a tapered surface 52 facing away from the seal part 42. A slip ring 44 is arranged adjacent each slip wedge 50. Each slip ring 44 also has a tapered surface 46 that faces the tapered surface 52 of the adjacent slip wedge 50. Jaws 48 can be disposed along the outer surface of each slip ring 44. A spacer ring 47 is disposed proximal of the proximal-most slip ring 44.

With additional reference to FIG. 2, once the plug 20 is arranged at a desired location within a well, a set structure can be triggered, creating a set force F that urges the spacer ring 46 distally and compresses the engagement portion 40 longitudinally between the spacer ring 46 and the distal slot wall 34. During this setting procedure, the longitudinally-directed set force F communicated to the engagement portion 40 is quite high. For example, setting tools can exert pressures in the range of 10,000-20,000 psi. Each slip ring 44 is pushed longitudinally against the adjacent slip wedge 50. The slip ring tapered surface 46 interacts with the slip wedge tapered surface 52. The tapered surfaces slide over one another and the slip ring 44 is forced radially outwardly so that its jaws 48 engage the well casing 54. The seal part 42 is also longitudinally compressed, forcing it to expand radially into sealing engagement with the bore of the well casing 54. In this arrangement, the slip rings 44 keep the plug 20 securely in position relative to the well casing 54 and the seal part 42 prevents fluid flow between the plug 20 and the well casing 54. A ball 56 can be advanced so that it is received in the ball seat 38, blocking fluids from flowing distally through the lumen 28, but allowing proximal fluid flow therethrough, similar to a check valve.

Frac plugs 20 can be made of various materials, but such materials must be able to endure rugged oil well conditions such as temperatures of about 250-350° F. and setting tool pressures of 10-20,000 psi. Also, during oil and gas operations, it is desired to remove the plug once it has completed its function. Such removal is typically performed by drill out in which a drill is used to remove the plug material. Plugs that employ metal components have proven difficult and time-consuming to drill out. Thus, composite materials, such as glass and/or carbon fibers entrained in an epoxy matrix, are often used to create such plugs 20. In particular for slip wedges 50, fibers entrained in an epoxy matrix have been shown to have advantageous hoop strength so as to communicate sufficient radial force to the slip rings 44 during the setting procedure. Such slip wedges 50 can be manufactured by, for example, a filament winding process.

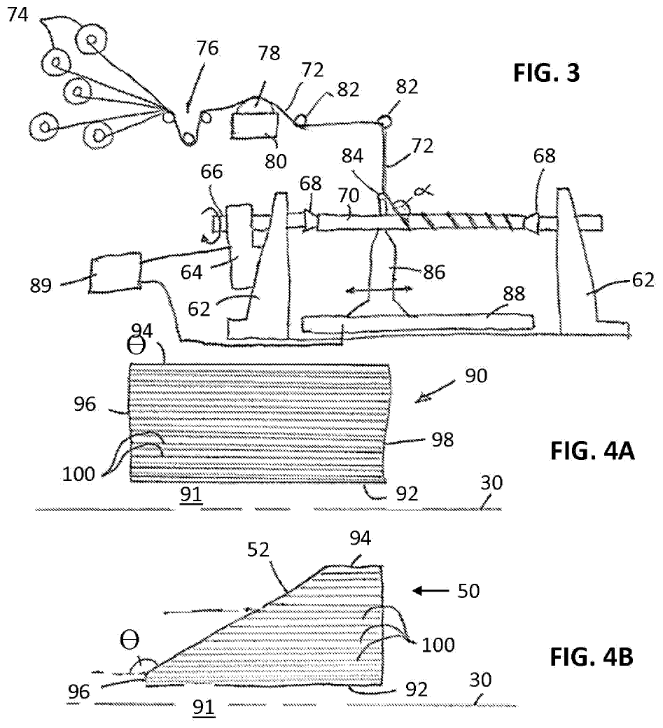

With reference next to FIG. 3, a filament winding apparatus 60, shown schematically, can include a frame 62 that supports a motor 64 configured to rotate an axle 66. Spindles 68 on the axle 66 can be configured to releasably hold a mandrel 70 upon which a filament 72 may be wound to create a part such as a wedge preform 90 (see FIGS. 4A, 6 and 8). A plurality of roving spools 74 can provide fibers to a tensioner 76, which combines fibers into a filament 72 that can be drawn over a resin drum 78 that rotates through a resin bath 80 so that the filament 72 becomes impregnated with epoxy resin. Further tensioners and re-directors 82 can direct the epoxy-impregnated filament 72 through an eye 84 that is carried by a carriage 86. The carriage 86 is supported on a track 88 and motorized so as to move back and forth generally parallel to the spinning mandrel 70.

As the mandrel 70 spins, filament 72 accumulates on the mandrel 70, forming layers of such filament 72. A winding angle α of each filament 72 as laid on the mandrel 70 is determined by the rotational speed of the mandrel and the translational speed of the carriage 86. Preferably, the motor 64 and carriage 86 are electronically controlled by a programmable controller 89 so that the winding angle α, number of layers, etc., can be strictly controlled. Once the part has been filament wound, it can be removed from the mandrel 70 and machined if desired. The result is a part that extends circumferentially around an axial opening, such as having an annular bore, where the mandrel 70 had been located. It is also to be understood that, in some embodiments, the filament that is wound about the mandrel 70 comprises many fibers, such as from the multiple roving spools 74, that can be compressed somewhat into a substantially flat tape that is wound about the mandrel 70. Such filament tape 72 preferably is applied to the mandrel 70 so that it is flat in a plane that is substantially parallel to surface of the mandrel 70.

With reference next to FIG. 4A, in some embodiments, a slip wedge like that of FIG. 1 can be formed by filament-winding a cylindrical wedge preform 90. The wedge preform 90 can then be machined to form the final dimension of the slip wedge, as further discussed below. For convenience, FIG. 4A shows a cross-section of one half of the wedge preform 90 about the axis 30. An inner surface 92 of the wedge preform faces the axial opening or bore 91. The outer surface 94 is a circumferential outer surface of the preform 90. The preform 90 further has a front surface 96 and back surface 98, which may also be referred to as first and second surfaces. Layers 100 of composite fibers are depicted schematically as lines. In this embodiment, the preform 90 was filament-wound by the carriage 86 moving back and forth so that the layers 100 are generally parallel to the mandrel 70, which is parallel to the longitudinal axis 30. This is particularly the case when the wound filament 72 comprises a substantially flat tape. In practice, the mandrel 70 (FIG. 3) rotates at a running speed, and he carriage 86 oscillates back-and-forth at another running speed, will cause each layer to be laid in a helix fashion and parallel to the surface of the mandrel.

With additional reference to FIG. 4B, the preform 90 can be machined to remove material so as to form the slip wedge 50 with the size and shape as desired for the intended application. As machined, the slip wedge 50 includes an inclined wedge surface 52. As discussed above, during the setting procedure, a substantial set force F is applied to the components of the engagement portion 40, including the slip wedge 50. The set force F acts in a direction parallel to the longitudinal axis 30 and thus, as shown, is applied generally parallel to the layers 100 of the slip wedge 50, resulting in substantial shear force tending towards inducing interlaminar shear of the layers in the slip wedge 50.

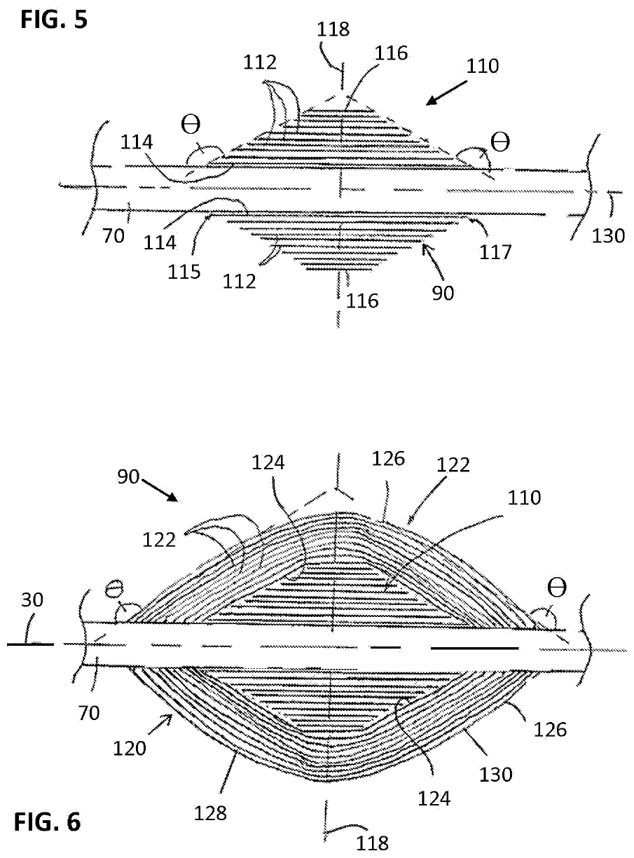

With reference next to FIG. 5, in accordance with another embodiment, a wedge preform 90 can be formed by first forming a first portion 110 comprises a plurality of first layers 112 of filament 72, most preferably full- or partially-flattened tape filament 72, wound about a mandrel 70. An innermost first layer 114 is applied to the mandrel 70 and thus is parallel to the longitudinal axis 30. The innermost first layer 114 has a first length from its first end 115 to its second end 117. During the filament winding process the carriage 86 moves back-and-forth to form subsequent first layers 112. The layers are connected as the carriage moves back-and-forth. As the thickness of the first portion 12 grows with the accumulation of first layers 112 during the filament winding process, the length of successively formed first layers 112 decreases so that the outermost first layer 116 has the shortest length, measured lengthwise of the mandrel. Preferably, the successive first layers 112 are wound so as to be symmetrical in length about a center line 118 or midway point of two ends, and the successive first layers 112 reduce in length fairly consistently as the first portion 110 grows in thickness towards the outermost layer 116. As such, opposing ends of the first portion 110 are inclined at an incline general angle θ. The two angles at the two ends, or opposite of the center line 118, can be substantially the same, such as within several degrees or some acceptable tolerance. As shown in FIG. 5, the first portion 110 comprises a plurality of first layers 112 that are substantially parallel to the longitudinal axis 30, having a thickness that tapers at incline angle θ while moving radially outwardly to a maximum thickness at the outermost first layer 116 and then tapers at the incline angle θ while moving radially inwardly to the mandrel 70.

With reference next to FIG. 6, a second portion 120 of the wedge preform 90 comprises a plurality of second layers 122 that are filament wound atop the first portion 110. As shown, an innermost second layer 124 is deposited directly on the first portion 110, following the incline angle θ upwardly and over the outermost first layer 116 and down again following the incline angle θ. Successive second layers 122, wound continuously by moving the carriage back-and-forth as the mandrel rotates, continue to follow this curvature developing a desired thickness. Most preferably, each successive second layer 122 completely covers the previous second layer 122. Thus, the two ends of teach successive layer, such as the length of the successive layer measured lengthwise of the mandrel, is generally longer than the length of the prior second layer 122. As such the first portion 110 is completely enclosed within the second portion 120. The outermost second layer 126 defines the outer shape of the wedge preform 90, and includes a first preform wedge surface 128 that is inclined generally at incline angle θ, a preform wedge outer surface that is generally parallel to the axis 30 and which is the thickest area of the wedge preform 90, and a second preform wedge surface 130 that is also inclined at generally at inclined angle θ. Most preferably the wedge preform 90 has dimensions that are slightly thicker and longer than the final desired dimensions of two back-to-back slip wedges 50. This allows two slip wedges to be machined from the single wedge preform 90 formed in accordance with aspects of the invention. Also, while it is desired that the inclined portions of the first portion 110 and second portion 120 have generally the same incline angle θ, it is to be understood that, during filament winding, variations may occur, and acceptable incline angles may be within about 10°, or more preferably within about 5°, of the desired incline angle θ.

After the filament winding process has been completed, the wedge preform 90 can be cured, such as in an oven for a duration at a baking temperature of about 200° F. to 400° F. to harden the resin. After curing, the wedge preform 90 can be machined to a desired final shape. Such machining can take place while the cured wedge preform 90 is still held on the mandrel 70, can be performed after the wedge preform 90 is removed from the mandrel 74, or a combination of such. Such machining can include milling, lathing, grinding, and sanding circumferentially, as well as cutting the wedge preform 90 along center line 118 so that one wedge preform 90 can be formed into two separate slip wedges 50.

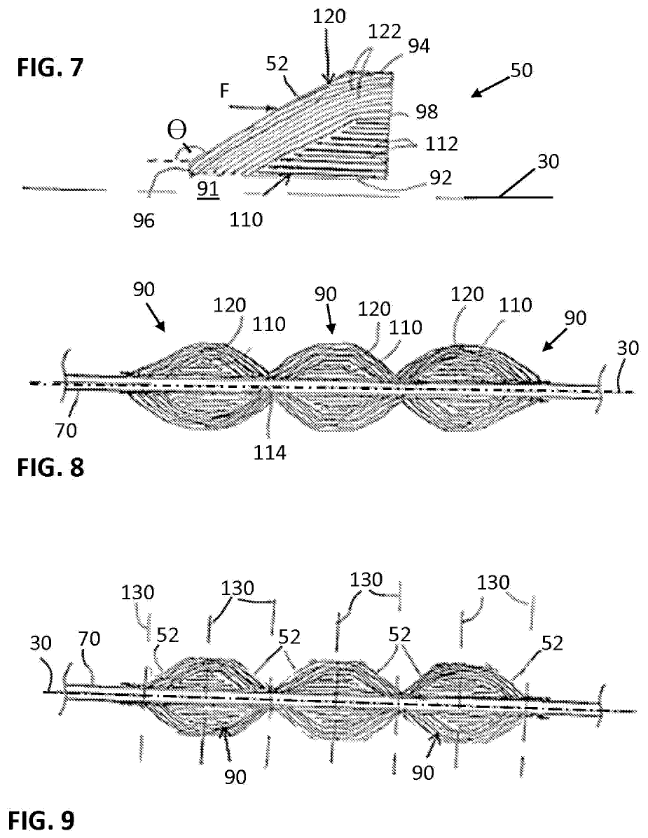

With reference next to FIG. 7, a cross-section of one half of the preform 90 machined into a slip wedge 50 is shown schematically. As shown, the slip wedge 50 has an inner surface 92 facing its axial aperture or defining the bore, which is parallel to the axis 30, and an opposing outer surface 94 that is also parallel to the axis 30 and which comprises the thickest portion of the slip wedge 50. The illustrated slip wedge 50 has a flat back surface 98 that is perpendicular to the axis 30 and, as shown in FIGS. 1 and 2, communicates set forces F to the seal part 42 of the engagement portion 40. The wedge surface 52 opposite the back surface 98 has been machined to be smooth and to have a substantially constant slope at the desired incline angle θ. In the illustrated embodiment, a short front surface 96 that is perpendicular to the axis 30 has been formed, truncating the tip of the wedge surface 52 to form a front end. Such front surface 96 can vary in height and can be optional, and preferably does not interfere with interaction between the slip wedge 50 and slip ring 44 during the setting process.

As depicted schematically in FIG. 7, the slip wedge 50 comprises the first portion 110, in which the first layers 112 are disposed generally parallel to the longitudinal axis 30, and the second portion 120. The second layers 122 at and adjacent the wedge surface 52 are disposed generally at the incline angle θ, and thus are generally parallel to the wedge surface 52. As discussed above, during the setting process, the tapered surface 46 of the slip ring 44 is pushed against the tapered wedge surface 52, and the slip ring surface 46 slides over the wedge surface 52 so that the slip ring 46 is pushed radially outwardly and into engagement with the well casing 54. The first layers 112 are oriented transversely to the direction of the set force F to provide great hoop strength sufficient to support the substantial forces pushing the slip ring 44 radially outwardly. As discussed above in FIG. 4, the set force F is directed onto the wedge surface 52 in a direction parallel to the longitudinal axis 30. While this set force F is parallel to the first layers 112 of the first portion 110 of the slip wedge 50, it is transverse to the second layers 122 of the second portion 120 of the slip wedge 50, which are positioned at and adjacent the wedge surface 52. As such, the second layers 122 provide enhanced resistance to forces that would tend to induce interlaminar shear between the first layers 112. In essence, the second layers 122 protect the first layers 112.

In some examples, the rotation of the mandrel 70 and the speed of the carriage 86 along the track, moving back-and-forth, can form first layers 112 having a helix pattern so that the first layers 112 also have layers that are transverse to the direction of the set force F. Further, as the second layers 122 are built-up onto the first layers 112 and into the football-like shape by controlling the back-and-forth reversal rates of the carriage and the rotational speed of the mandrel, the second layers 122 can include some random orientations and less uniform than depicted, particularly near the front end 96. Because of the movement of both the mandrel and the carriage, the majority of second layers 122 are known to lie transverse to the set force F such that when the preform 90 is machined into two separate slip wedges 50, the set force F is transverse to the majority of the second layers 122 of the slip wedge 50 when the slip wedge is in use. As such, the second layers 122 provide enhanced resistance to forces that would tend to induce interlaminar shear between the first layers 112.

In some examples, the wedge preform 90 (FIG. 6) used to create the slip wedge 50 (FIG. 7) may be created with a plurality of first layers 112 of the first portion 110 only, without utilizing layers of the second portion. As discussed above, during the winding process, the filaments 72 (FIG. 3) used to form the first layers 112 are dispensed through one or more eyes under the back-and-forth movement of the carriage 86. Movement of the carriage and rotation of the mandrel cause the filaments to be laid in a helix pattern in both the forward and reverse directions of the carriage. This pattern forms a plurality of overlaid helix layers, many of which are disposed transversely to the set force F that is generated when the slip wedge 50 is in used and acted upon by the engagement portion 40 (FIG. 1). Thus, the slip wedge 50 may be formed by first forming a football-like shape composite structure or preform having a plurality of first layers 112 and then machining the preform to produce two spaced apart of separate slip wedges 50, each with an inclined surface for cooperating with a slip ring.

The above embodiments have depicted filament winding of a single wedge preform 90 that can be machined into two slip wedges 50. It is to be understood that various specific manufacturing methods and apparatus can be employed to form parts employing the principles discussed herein. It is also envisioned that a plurality of wedge preforms 90 can be made simultaneously. For example, with reference next to FIG. 8, a single mandrel 70 has a plurality of wedge preforms 90 filament wound thereon. Three preforms are shown in the illustrated embodiment, but it is to be understood that any number of preforms can be formed simultaneously. The controller 89 (FIG. 3) of the filament-winding apparatus 60 preferably can be programmed to control the rotation of the mandrel 70 and translation of the carriage 86 so as to create a plurality of wedge preforms 90 having first portions 110 and second portions 120.

It is also to be understood that forming of the first and second portions 110, 120 can include some acceptable variations from the embodiments specifically discussed herein. For example, in the embodiment illustrated in FIG. 8, the innermost layer 114 of the first portion 110 of the multiple wedge preforms 90 extends along the entire length of these filament wound parts. Successive first layers 112 can be formed as discussed above, by the carriage 86 moving back and forth to build the thickness with the desired incline angle θ, and second layers 122 can encapsulate the rest of the first layers 112. After one first portion 110 is formed, the carriage 86 can move on to the next, in which successive layers increase the thickness of the first portion 110 while defining the desired inclines. Although a continuous filament can be used for all of the first portions 110, the filament between first portions 110, which will be deposited in layers generally parallel to the axis 30, will be relatively thin, and will not make up a significant portion of the wedge surface 52 after the wedge preform 90 is machined. In additional embodiments, the filament 72 can be cut and restarted to form each first portion 110 on the mandrel 70.

In additional embodiments, successive first layers 112 of the first portions 110 can be formed simultaneously. For example, the mandrel 70 and/or carriage 86 can be controlled so that a very little quantity of filament 72 is deposited between adjacent first portions 110 in each pass. Thus, the winding angle α between first portions 110 would be greater than the winding angle α within first portions 110. It is to be understood that there may be some filament layers that are not consistent with the schematically depicted layers. However, it is anticipated that the overall pattern of deposited layers will employ principles discussed herein, even though variations in angles and specific shapes can be anticipated.

Once the first portions 110 have been formed, the second portions 120 can be wound atop the first portions 110. Similarly as discussed above, such second portions 120 can be formed by the carriage 86 moving back and forth depositing layers 122 atop each first portion 110 independently, or in other embodiments making passes depositing a layer of filaments 72 over the entire working length of the mandrel 70, and over all of the first portions 110, in each pass. It is anticipated that, in some winding procedures, some portions of second layers 120, such as at the edges and between adjacent wedge preforms 90, and adjacent the mandrel 70, may be substantially parallel to the longitudinal axis 30. Preferably such layers are limited to the area adjacent the inner surface 92.

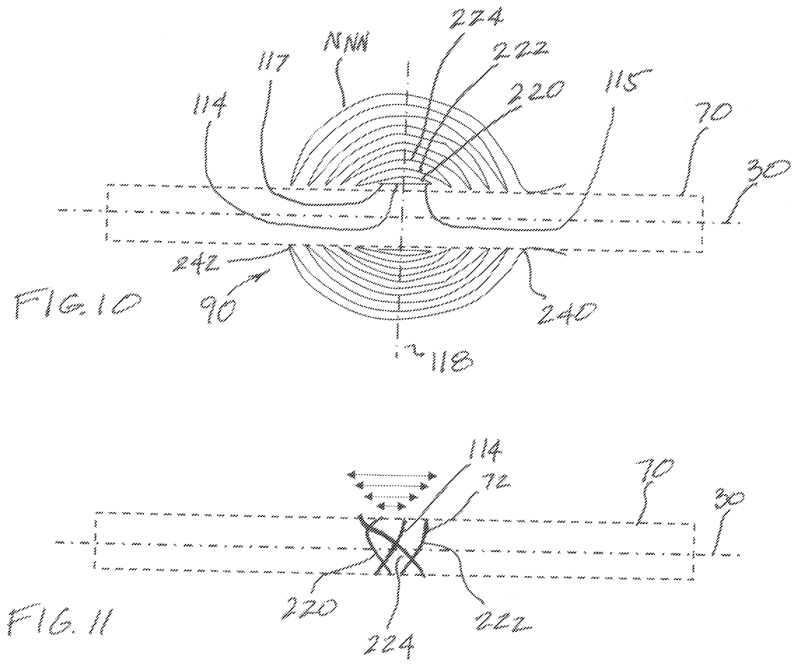

With reference next to FIG. 9, once the multiple preforms 90 have been filament-wound on the mandrel 70 and cured, they can be machined generally to the desired final shape of slip wedges 50. The multiple preforms 90 can then be removed from the mandrel 70 and cut along cut lines 130 so as to form a plurality of slip wedges 50. In an example, each preform 90, which has a central section having an outer diameter greater than outer diameters at the two ends and can resemble a football-like structure, also known as a prolate spheroid shape, can be machined to form two slip wedges.

In the illustrated embodiments, the second layers 122 have been deposited at angle which is substantially the same as the desired final incline angle θ of the wedge surface 52. It is to be understood that, in additional embodiments, the second layers 122 can vary substantially from this final incline angle θ. Preferably, however, the second layers 122 will be configured so that the applied set force F is transverse to, and not parallel to, the second layers 122. Said differently, the second layers 122 should be formed by laying down transverse laminate layers to the longitudinal axis 30, when forming the football-like preform 90 structure in accordance with aspects of the invention, so that when a parallel set force F to the longitudinal axis 30 is experienced, the slip wedge resists interlaminate shear induced by the applied force.

In a preferred embodiment, the slip wedge 50 is formed of a composite comprising glass fibers entrained in an epoxy matrix. It is to be understood that, in other embodiments, a wide range of matrices, including epoxy and/or other resins, can be used, and other types of fibers, such as carbon or aramid fibers, can be used.

The controller 89 of the filament-winding apparatus 60 can be programmed with any number of winding patterns. And it is to be understood that a variety of winding patterns and angles can be suitably employed as appropriate. In a preferred embodiment, for depositing the first layers 112 and second layers 122, a winding angle α in the range of about 53°-64°, and more preferably about 57°, is employed. Of course, in additional embodiments, the winding angle in the first portion 110 can be different than the winding angle in the second portion 120.

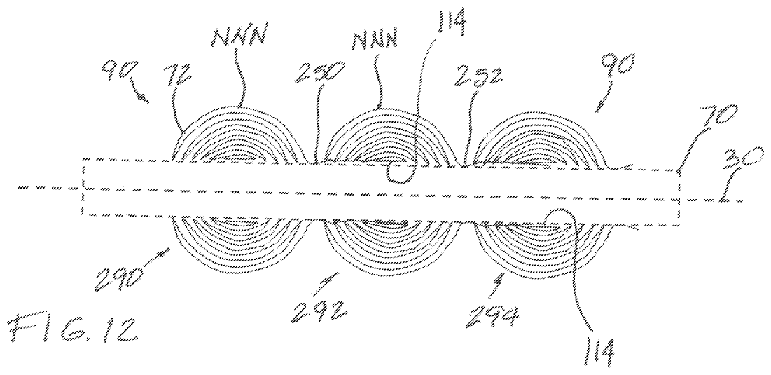

With reference next to FIG. 10, in accordance with another embodiment, a wedge preform 90 can be formed by laying a filament 72 on a mandrel 70 (FIG. 3) from a center starting point and then winding the filament both axially outwardly and radially layer by layer via the rotating motion of the mandrel 70 and the traversing motion of the carriage 86 (FIG. 3). An innermost first layer 114 is applied to the mandrel 70 and thus is parallel to the longitudinal axis 30. The innermost first layer 114 has a first length from its first end 115 to its second end 117. Preferably, the first length of the first innermost layer 114 is generally the shortest length among the multiple layers of the preform 90, which is being formed from the shortest center layer out axially and radially. During the filament winding process, the carriage 86 moves back-and-forth to form subsequent layers 220, 222, 224, etc. and ends with the last outermost layer NNN, which has a final length from its first end 240 to its second end 242, which is generally the longest length among the multiple layers of the preform 90. The layers are connected as the carriage moves back-and-forth and the mandrel rotates. Each subsequent layers formed starting from the first innermost layer 114 is preferably longer than the prior layer so as to grow the structure from the center out in both the axial direction of the longitudinal axis 30 and the radial direction, radial relative to the longitudinal axis 30.

As the length of the structure grows by programming the carriage 86 to incrementally traverse back-and-forth longer for each subsequent paths following the first path to lay incrementally longer subsequent layers, the thickness of the structure, in the radial direction relative to the longitudinal axis 30, also grows by the filament 72 being laid layer by layer on top of itself to terminate with the outermost layer NNN. With the accumulation of layers 114, 220, 222, 224 . . . NNN and because the filament is being wound from the center out starting with the innermost shortest layer, the structure resembles a football with the central part of the structure being the thickest, also known as a prolate spheroid shape.

Preferably, the successive layers 220, 222, 224 . . . NNN are wound so as to be incrementally longer and symmetrical in length about a center line 118 or midway point of two ends, and the successive layers increase in length fairly consistently from the innermost layer 114 towards the outermost layer NNN. In an example, there are at least five layers with each layer having a length. Preferably, there are at least eight layers with each layer having a length. More preferably, there are at least 12 layers with each layer having a length. The length of the outermost layer is longer than the length of the inner most layer. The length of the outermost layer is longer than the length of the second through fourth layers. In a most preferred embodiment, the length of the outermost layer is the longest of the layers of the preform. Further, as the mandrel 70 rotates and the carriage 86 (FIG. 3) traverses along the track, the second and subsequent layers 220, 222, 224, . . . NNN can include some random orientations and less uniform than depicted. For example, the filament will have a spiral or helix pattern as it traverses back and forth on the rotating mandrel. Thus, in the present construction of the preform 90, the majority of the layers can lie transverse to the set force during use such that when the preform 90 is machined into two separate slip wedges 50, the set force F is transverse to the majority of the layers of the slip wedge 50. As such, the formation of layers to form the preform 90 shown that begins with the shortest innermost layer 114 and then wound so as to be incrementally longer and symmetrical in length about a center line 118 or midway point of two ends towards the outermost layer NNN have transverse fibers that provide enhanced resistance to forces that would tend to induce interlaminar shear between the layers.

Although not shown, the preform 90 of FIG. 10 is understood to be machined to size and shape before it can be used as a slip wedge. As previously discussed, the preform 90 can be machined by cutting into two and then machined to form two slip wedges.

FIG. 11 is a schematic depiction of the filament 72 being wound as layer 114, layer 220, layer 222, layer 224, and so forth to form the preform 90 of FIG. 10. As shown, when the mandrel 70 rotates and the carriage 86 (FIG. 3) moves back and forth, the layers and being laid down in a helix-like pattern and the fibers are formed transversely to the longitudinal axis 30 of the hollow center. The transverse fibers provide enhanced resistance to forces that would tend to induce interlaminar shear between the layers.

With reference now to FIG. 12, the wedge preform 90 (FIG. 10) used to form two slip wedges, after post-form machining, may be formed in series to create a plurality of preforms each with similar patterns. In an example, after a first unit 290 of the preform 90 is formed, the filament 72 forming the outermost layer NNN is laid down as a single layer 250 onto another section of the mandrel 70 to then form the innermost layer 114 of the second unit 292 forming the second preform 90. Then when the last or outermost layer NNN of the second unit 292 is formed, the filament is laid down to form a second single layer 252 onto another section of the mandrel 70 to then form the innermost layer 114 of the third unit 292 forming the third preform 90. The process can continue to form as many composite units defining preforms in accordance with aspects of the invention as the length of the mandrel allows.

The embodiments discussed above have disclosed structures with substantial specificity. For example, apparatus, method of making, and method of using a slip wedge from a preform in a frac plug or a bridge plug in accordance with aspects of the invention have been disclosed. This has provided a good context for disclosing and discussing inventive subject matter. However, it is to be understood that other embodiments may employ different specific structural shapes and interactions.

Although inventive subject matter has been disclosed in the context of certain preferred or illustrated embodiments and examples, it will be understood by those skilled in the art that the inventive subject matter extends beyond the specifically disclosed embodiments to other alternative embodiments and/or uses of the invention and obvious modifications and equivalents thereof. In addition, while a number of variations of the disclosed embodiments have been shown and described in detail, other modifications, which are within the scope of the inventive subject matter, will be readily apparent to those of skill in the art based upon this disclosure. It is also contemplated that various combinations or sub-combinations of the specific features and aspects of the disclosed embodiments may be made and still fall within the scope of the inventive subject matter. Accordingly, it should be understood that various features and aspects of the disclosed embodiments can be combined with or substituted for one another in order to form varying modes of the disclosed inventive subject matter. Thus, it is intended that the scope of the inventive subject matter herein disclosed should not be limited by the particular disclosed embodiments described above, but should be determined only by a fair reading of the claims that follow.

What is claimed is:

1. A composite frac plug or bridge plug, comprising:
an elongated mandrel having a longitudinal axis and supporting an expansion portion, the expansion portion comprising a seal part, a slip ring, and a slip wedge between the seal part and the slip ring, the slip wedge having an inclined wedge surface disposed in engagement with the slip ring and inclined at a wedge angle relative to the longitudinal axis;
the expansion portion configured to be longitudinally compacted upon application of a set force that is applied in a direction parallel to the longitudinal axis;
wherein the slip ring and slip wedge are configured so that when the expansion portion is longitudinally compacted the slip ring engages the wedge surface and slides longitudinally over the wedge surface and is pushed radially outwardly by the wedge surface; and
the slip wedge comprising a first layer defining a bore of the slip wedge, a second layer disposed over the first layer, a third layer disposed over the second layer, and at least three additional layers disposed over the third layer that include an outermost layer, and wherein the outermost layer is formed from a filament layer having a length that is longer than a length of the first layer, a length of the second layer, and a length of the third layer.

2. The composite frac plug or bridge plug of claim 1, wherein the slip ring comprises a tapered slip ring surface, and the tapered slip ring surface is adjacent the wedge surface.

3. The composite frac plug or bridge plug of claim 1, additionally comprising a set structure configured to communicate a set force to the expansion portion, the set force being exerted in a longitudinal position onto the wedge surface.

4. A composite slip wedge, comprising:
an elongated body having a longitudinal axis and an axial opening along the longitudinal axis, the elongated body extending circumferentially about the longitudinal axis;
an innermost surface facing the axial opening;
an outermost surface opposite the inner surface;
a wedge surface intersecting the outermost surface, the wedge surface inclined at a wedge angle;
a first layer defining the innermost surface of the slip wedge, a second layer disposed over the first layer, a third layer disposed over the second layer, and at least three additional layers disposed over the third layer that include the outermost layer; and
wherein the outermost layer is formed from a filament layer having a length that is longer than a length of the first layer, a length of the second layer, and a length of the third layer.

5. A method of making a composite slip wedge, comprising:
forming a wedge preform, forming the wedge preform comprising:
filament-winding a plurality layers of matrix-entrained fibers on a mandrel and successively on top of one another;
wherein the plurality of layers comprise a first layer defining a bore of the preform, a second layer disposed over the first layer, a third layer disposed over the second layer, and at least three additional layers disposed over the third layer that include an outermost layer; and
wherein the outermost layer is formed from a filament layer having a length that is longer than a length of the first layer, a length of the second layer, and a length of the third layer.

6. The method of claim 5, wherein the preform has a prolate spheroid shape.

7. The method of claim 5, wherein a mid point of the preform has a thickness that is wider than a thickness at each of two ends of the preform.

8. The method of claim 5, wherein each winding pass forms a layer.

9. The method of claim 5, comprising laying a strand of fibers that form the outermost layer to another section of the matrix to form an innermost layer of a second preform.

10. The method of claim 9, comprising laying a strand of fibers that form the outermost layer of the second preform to another section of the matrix to form an innermost layer of a third preform.
